(19) United States
(12) Patent Application Publication
(10) Pub. No.: US 2013/0135603 A1
(43) Pub. Date: May 30, 2013

(54) C-CORE ACTUATOR FOR MOVING A STAGE

(71) Applicant: NIKON CORPORATION, Tokyo (JP)

(72) Inventors: Michael Binnard, Belmont, CA (US); Scott Coakley, Belmont, CA (US); Yoichi Arai, Saitama-ken (JP); Rick K. Ingram, Chino Hills, CA (US)

(73) Assignee: NIKON CORPORATION, Tokyo (JP)

(21) Appl. No.: 13/689,071

(22) Filed: Nov. 29, 2012

Related U.S. Application Data
(60) Provisional application No. 61/565,343, filed on Nov. 30, 2011.

(51) Int. Cl. B65G 54/02; G03B 27/58; H02K 41/025

(52) U.S. Cl. CPC B65G 54/02; H02K 41/025; G03B 27/581
USPC 355/72; 198/619; 310/12.06

(57) ABSTRACT

A mover assembly (46) for moving a stage (14) includes an actuator (30) that is coupled to the stage (14). The actuator (30) includes (i) a C-Core (52) having a generally “C” shape and including a first transverse leg (260), a second transverse leg (262) that is spaced apart from the first transverse leg (260), and a connector region (264) that connects the transverse legs (260), (262); (ii) a coil (270) that is wrapped around the first transverse leg (260); and (ii) an I core (250) that is spaced apart a gap (254) from the C-Core (252).

### RELATED INVENTION

This application claims priority on U.S. Provisional Application Ser. No. 61/565,343, filed Nov. 30, 2011 and entitled “C-CORE ACTUATOR FOR MOVING A STAGE”. As far as permitted, the contents of U.S. Provisional Application Ser. No. 61/565,343 are incorporated herein by reference.

### BACKGROUND

Exposure apparatuses are commonly used to transfer images from a reticle onto a semiconductor wafer during semiconductor processing. A typical exposure apparatus includes an illumination source, a reticle stage assembly that retains and positions a reticle, a lens assembly, and a wafer stage assembly that retains and positions a semiconductor wafer. The size of the images and the features within the images transferred onto the wafer from the reticle are extremely small. Accordingly, the precise relative positioning of the wafer and the reticle is critical to the manufacturing of high density, semiconductor wafers.

Recently, E/I core type actuators, normally in opposing pairs, have been used in the wafer stage assembly and/or the reticle stage assembly. E/I core type actuator pairs include a pair of generally “E” shaped electromagnets and a pair of “I” shaped targets that are positioned between the two electromagnets. Each “E” shaped electromagnet has an electrical coil wound around it, typically around its center section.

Unfortunately, existing actuators are not entirely satisfactory for use in exposure apparatuses.

### SUMMARY

The present invention is directed to a mover assembly for moving a stage. In one embodiment, the mover assembly includes a first actuator that is coupled to the stage. In certain embodiments, the first actuator includes (i) a C-Core that is generally “C” shaped and has a first transverse leg, a second transverse leg that is spaced apart from the first transverse leg, and a connector region that connects the transverse legs; (ii) a coil that is wrapped around the first transverse leg; and (iii) an I core that is spaced apart a gap from the C-Core.

As provided herein, because the coil is wrapped around one of the transverse legs (as opposed to the connector region), the asymmetrical configuration moves a portion of the heat generating component (the coil) away from the center of the actuator, while still maintaining the push point of the actuator near the center of the C-Core. This asymmetric design allows for the coil for each actuator to be positioned farther from sensitive components and the actuator push point to be positioned closer to a desired location, e.g., the center of gravity of the stage being moved by the actuator.

The mover assembly can additionally include a second actuator that is coupled to the stage, the second actuator having (i) a C-Core that is somewhat “C” shaped and that includes a first transverse leg, a second transverse leg that is spaced apart from the first transverse leg, and a connector region that connects the transverse legs; (ii) a coil that is wrapped around the first transverse leg; and (iii) an I core that is spaced apart a gap from the C-Core.

In certain embodiments, the mover assembly includes a control system that directs current to the coil of the first actuator to attract the cores of the first actuator together, and directs current to the coil of the second actuator to attract the cores of the second actuator together. With this design, the actuators form an attraction only, electromagnetic actuator pair that can be controlled to position the stage.

The present invention is also directed to a stage assembly, an exposure apparatus, a device manufactured with the exposure apparatus, and/or a wafer on which an image has been formed by the exposure apparatus. Further, the present invention is also directed to a method for moving a stage, a method for making a stage assembly, a method for making an exposure apparatus, a method for making a device and a method for manufacturing a wafer.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified side view of a stage assembly having features of the present invention;

FIG. 2A is a simplified side view, and FIG. 2B is a simplified perspective view of a C-Core actuator having features of the present invention;

FIG. 2C is a simplified perspective view of a portion of the C-Core actuator of FIGS. 2A and 2B;

FIG. 2D is a cut-away view taken on line 2D-2D in FIG. 2C;

FIG. 2E is a simplified perspective view of a yet another portion of the C-Core actuator of FIGS. 2A and 2B;

FIG. 2F is a simplified illustration of a portion of the C-Core actuator;

FIG. 2G is a simplified side illustration of another actuator pair having features of the present invention;

FIG. 3 is a schematic illustration of an exposure apparatus having features of the present invention;

FIG. 4A is a flow chart that outlines a process for manufacturing a device in accordance with the present invention; and

FIG. 4B is a flow chart that outlines device processing in more detail.

### DESCRIPTION

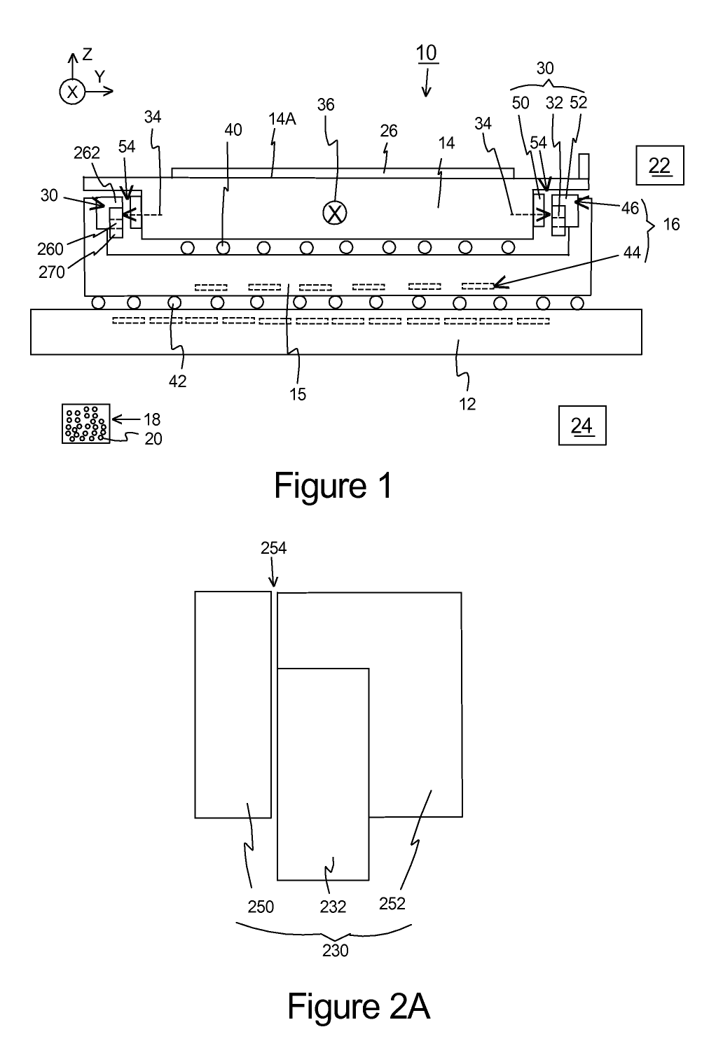

Referring initially to FIG. 1, a stage assembly 10 having features of the present invention includes a stage base 12, a fine stage 14, a coarse stage 15, a stage mover assembly 16, a circulation system 18 (illustrated as a box) that directs a circulation fluid 20 (e.g. a coolant illustrated with circles) through at least a portion of the stage mover assembly 16, a measurement system 22, and a control system 24. The design of each of these components can be varied to suit the design requirements of the stage assembly 10. It should be noted that the stage base 12, the fine stage 14, the coarse stage 15 can alternatively be referred to a first stage or a second stage.

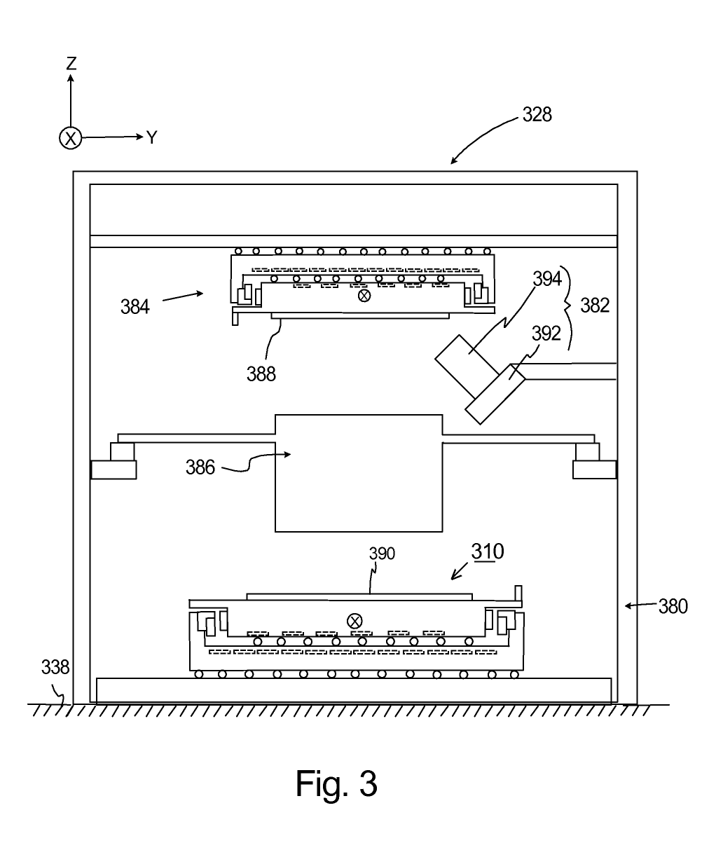

The stage assembly 10 is particularly useful for precisely positioning a device 26 during a manufacturing and/or an inspection process. The type of device 26 positioned and moved by the stage assembly 10 can be varied. For example, the device 26 can be a semiconductor wafer, and the stage assembly 10 can be used as part of an exposure apparatus 328 (illustrated in FIG. 3) for precisely positioning the semiconductor wafer during manufacturing of the semiconductor wafer. Alternately, for example, the stage assembly 10 can be used to move other types of devices during manufacturing and/or inspection, to move a device under an electron microscope (not shown), or to move a device during a precision measurement operation (not shown).

As an overview, in certain embodiments, the stage mover assembly 16 includes one or more actuators 30 (two are illustrated in FIG. 1) that are uniquely designed in an asymmetric configuration so that a conductor assembly 32 (e.g. the heat generating part) of each actuator 30 can be positioned farther away from sensitive components (as compared to a symmetric configuration), and/or so that an actuator push point 34 (illustrated as a dashed arrow) of each actuator 30 is closer to a center of gravity 36 of the object being moved by the C-Core actuators 30. For example, in FIG. 1, because of the asymmetric configuration, each conductor assembly 32 is positioned farther away from temperature-sensitive components, such as the device 26 and/or portions of the measurement system 22.

Further, because of the asymmetric configuration, the actuator push point 34 of each actuator 30 can be easier to align with the center of gravity 36 of the combination of the fine stage 14 and the device 26. As a result thereof, the actuators 30 can move the fine stage 14 and the device 26 with more accuracy.

Some of the Figures provided herein include an orientation system that designates an X axis, a Y axis, and a Z axis. It should be understood that the orientation system is merely for reference and can be varied. For example, the X axis can be switched with the Y axis and/or the stage assembly 10 can be rotated. Moreover, these axes can alternatively be referred to as a first, second, or third axis.

In the embodiments illustrated herein, the stage assembly 10 includes a single fine stage 14 that retains a single device 26. Alternately, for example, the stage assembly 10 can be designed to include multiple fine stages that are independently moved.

The stage base 12 supports a portion of the stage assembly 10 above a mounting base 338 (illustrated in FIG. 3). In the embodiment illustrated herein, the stage base 12 is generally rectangular plate shaped.

The fine stage 14 retains the device 26. In one embodiment, the fine stage 14 is precisely moved by the stage mover assembly 16 to precisely move and position the device 26. In FIG. 1, the fine stage 14 is generally rectangular shaped, and includes a supporting portion 14A that supports the device 26. For example, the supporting portion 14A can include a device holder (not shown) for retaining the device 26. The device holder can be a vacuum chuck, an electrostatic chuck, or some other type of clamp.

The fine stage 14 is maintained above the coarse stage 15 with a first stage bearing 40 (illustrated with small circles) that allows for motion of the fine stage 14 relative to the coarse stage 15. As non-exclusive examples, the first stage bearing 40 can be a vacuum preload type fluid bearing, a magnetic type bearing, or a roller bearing type assembly.

In one embodiment, the coarse stage 15 is precisely moved by the stage mover assembly 16 to follow the movement of the fine stage 14. In FIG. 1, the coarse stage 15 is generally rectangular shaped. Further, the coarse stage 15 is maintained above the stage base 12 with a second stage bearing 42 (illustrated with small circles) that allows for motion of the coarse stage 15 relative to the stage base 12. For example, the second stage bearing 42 can be a vacuum preload type fluid bearing, a magnetic type bearing, or a roller bearing type assembly.

The design of the stage mover assembly 16 can be varied to suit the movement requirements of the stage assembly 10. In FIG. 1, the stage mover assembly 16 includes a coarse mover assembly 44 (illustrated in phantom) that moves and positions of the coarse stage 15 relative to the stage base 12 to follow the movement of the fine stage 14, and a fine mover assembly 46 that moves and positions of the fine stage 14 relative to the coarse stage 15.

The mover assemblies 44, 46 can move each of the respective stages 14, 15 with six or less degrees of freedom. For example, the coarse mover assembly 44 can be a planar motor that moves the coarse stage 15 along the X axis, along the Y axis, and about the Z axis (collectively “the planar degrees of freedom”).

Further, in the simplified example illustrated in FIG. 1, the fine mover assembly 46 includes a single pair of opposed actuators 30 that cooperate to move the fine stage 14 along the Y axis. Typically, the fine mover assembly 46 will include more than one pair of opposed actuators 30, and may include additional actuators of different types. For each pair of opposed actuators 30, one of the actuators 30 can be referred to as a first actuator and the other of the actuators 30 can be referred to as a second actuator. Each actuator 30 can also be referred to as a C-Core actuator.

In FIG. 1, (i) each of the C-Core actuators 30 is an attraction only, electromagnetic actuator, (ii) the two C-Core actuators 30 form an actuator pair that can be used to move the object back and forth along an axis (e.g, the Y axis), (iii) the C-Core actuators 30 are mounted so that the attractive force produced by each C-Core actuator 30 is substantially parallel with the Y axis, and (iv) the actuator push point (or pull point) 34 of each C-Core actuator 30 is aligned with the center of gravity 36 of the object being moved. With this arrangement, the C-Core actuators 30 can make fine, precise adjustments to the position of the fine stage 14 and the device 26 along the Y axis.

As provided herein, each C-Core actuator 30 includes an I-Core 50, a C-Core 52 that is spaced apart a gap 54 (greatly exaggerated in FIG. 1 for clarity) from the I-Core 50, and the conductor assembly 32 that is positioned around the C-Core 52. In FIG. 1, for each C-Core actuator 30, the I-Core 50 is secured to the fine stage 14, and the C-Core 52 is secured to the coarse stage 15. Alternatively, for each C-Core actuator 30, the I-Core 50 can be secured to the coarse stage 15, and the C-Core can be secured to the fine stage 14.

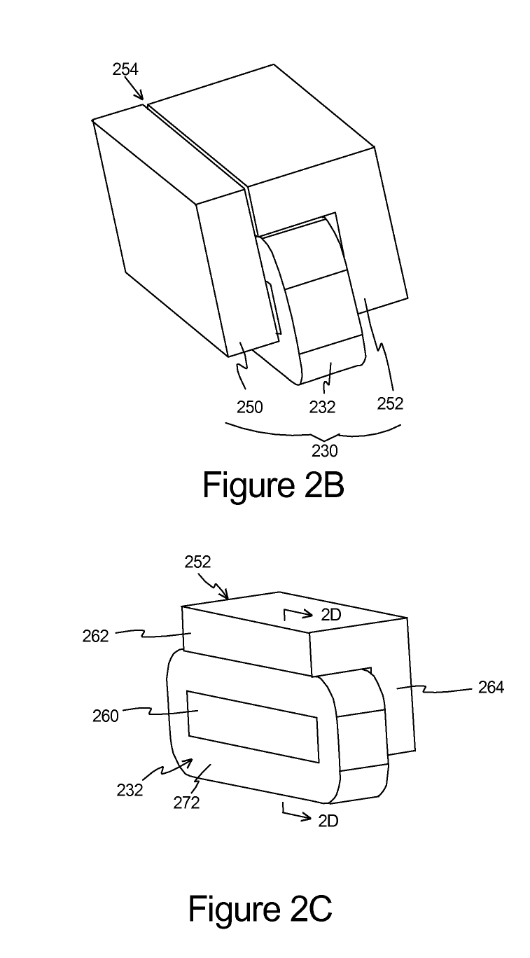

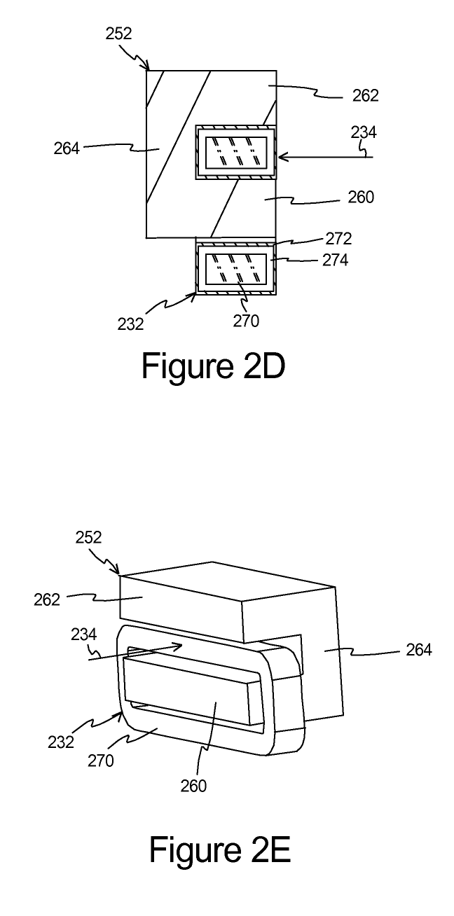

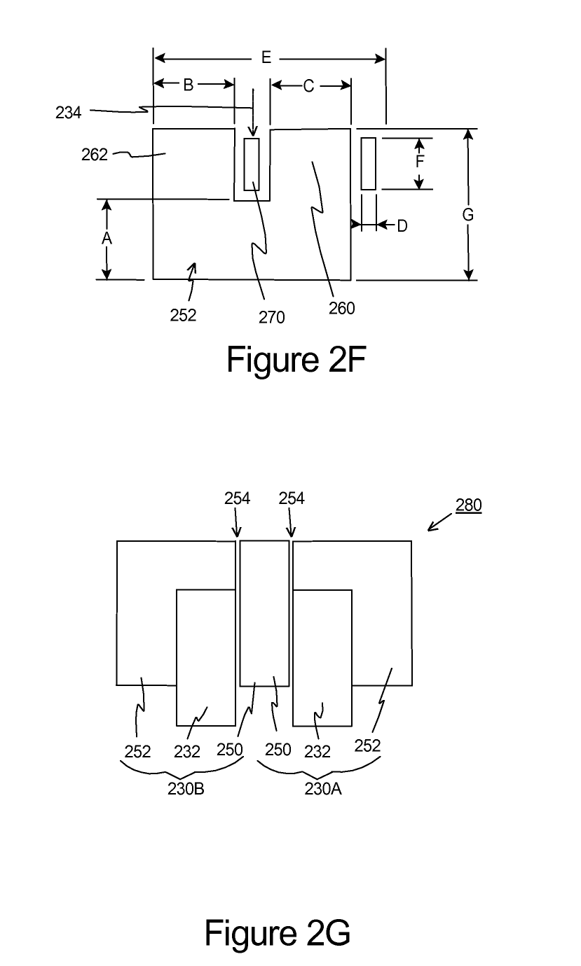

As provided herein, the I-Core 50 of the first, right actuator 30 and the I-Core 50 of the left, second actuator 30 can be collectively referred to as an I-Core assembly. Still alternatively, the actuator pair can be designed and positioned so that the two actuators 30 share a common I-Core 50, as illustrated in FIG. 2G. In this embodiment, the I-Core assembly includes a single I-Core 50.

The control system 24 independently directs electrical current to the conductor assembly 32 of each C-Core actuator 30 to position the fine stage 14. For each C-Core actuator 30 of each pair, current directed through the conductor assembly 32 creates a magnetic field that attracts the I-Core 50 toward the C-Core 52 through the principle of variable reluctance. For each C-Core actuator 30, the amount of attraction that is generated is determined by the amount of current and the size of the gap 54. If the gaps 54 are equal, by making the current through one conductor assembly 32 of the pair to be larger than the current through the other conductor assembly 32, a differential force can be produced to draw the I-Cores 50 in one direction or its opposing direction. This resultant force can be used to move the fine stage 14 or another type of device.

More specifically, (i) for the right C-Core actuator 30, current through the conductor assembly 32 generates a magnetic field that attracts its I-Core 50 towards its C-Core 52, and results in an attractive first force F₁; and (ii) for the left C-Core actuator 30, current through the conductor assembly 32 generates an electromagnetic field that attracts its I-Core 50 towards its C-Core 52, and results in an attractive second force F₂. The size of the gap 54 and the amount of current determines the amount of attraction. With this design, the right actuator 30 urges the fine stage 14 with a controlled first force F₁ (not shown) in one direction (to the right along the Y axis), and the left actuator 30 urges the fine stage 14 with a controlled second force F₂ (not shown) in the opposite direction (to the left along the Y axis). The net force ΔF is the difference between the first force F₁ and the second force F₂.

Thus, F₁−F₂=ΔF. equation 1

F₁ and F₂ are positive or zero, while the ΔF can be positive, zero, or negative.

When the first force F₁ is equal to the second force F₂ (e.g., when both F1 and F2 are substantially zero), the net force ΔF generated by the actuator pair on the fine stage 14 is equal to zero and there is no acceleration of the fine stage 14. However, (i) when the first force F₁ is greater than the second force F₂, the net force ΔF is positive, and the actuator pair moves the fine stage 14 to the right along the Y axis (in the +Y direction), and (ii) when the second force F₂ is greater than the first force F₁, the net force EF is negative, and the actuator pair moves the fine stage 14 to the left along the Y axis (in the −Y direction). The amount of movement is determined by the magnitudes of force F₁ and F₂.

Unfortunately, the electrical current in the conductor assemblies 32 generate heat, due to resistance in the conductor assemblies 32. The heat can subsequently be transferred to the other components of the stage assembly 10. This can cause thermal expansion and distortion of these components. Further, the heat from the conductor assemblies 32 can be transferred to the air surrounding the conductor assemblies 32. This can adversely influence the measurement system 22, or other components of the exposure apparatus 328.

In certain embodiments, the circulation system 18 can be used to reduce the influence of the heat from the conductor assemblies 32 by actively cooling the conductor assemblies 32, thereby reducing the amount of heat transferred from the conductor assemblies 32 to the surrounding environment. With this design, the stage mover assembly 16 can position the device 26 with improved accuracy, and the exposure apparatus 328 is capable of manufacturing higher precision devices, such as higher density, semiconductor wafers.

The design of the circulation system 18 can vary. In one embodiment, the circulation system 18 directs the circulation fluid 20 through one or more passageways around or in each conductor assembly 32. For example, the circulation system 18 can include multiple fluid pumps and multiple reservoirs. Moreover, the circulation fluid 20 that is directed through the passageways can be returned to the reservoir for a closed loop circulation system.

In one embodiment, the flow rate and temperature of the circulation fluid 20 can be controlled to remove the heat from the conductor assemblies 32 and maintain the outer surface of the conductor assemblies 32 at a predetermined temperature, e.g. the temperature of the room or chamber that houses the stage assembly 10. By controlling the temperature of the outer surface, the amount of heat transferred from the conductor assemblies 32 to the surrounding environment can be controlled and minimized.

The measurement system 22 monitors movement of the fine stage 14 relative to some reference, such as an optical assembly. With this information, the stage mover assembly 16 can be controlled to precisely position the fine stage 14 and object 26. For example, the measurement system 22 can utilize laser interferometers, encoders, and/or other measuring devices to monitor the position of the stage 14.

The control system 24 is electrically connected to, directs and controls electrical current to the stage mover assembly 16 to precisely position the device 26. For example, the control system 24 can independently direct current to each of the conductor assemblies 32. Further, the control system 24 can receive feedback from the measurement system 22 for closed loop position control. Further, the control system 24 can be electrically connected to and control the circulation system 18 to accurately control the temperature of the conductor assemblies 32. The control system 24 can include one or more processors.

FIG. 2A is a simplified side view, and FIG. 2B is a simplified perspective view of a C-Core actuator 230 having features of the present invention that can be used in the stage assembly 10 of FIG. 1. In this embodiment, the C-Core actuator 230 includes the I-Core 250, the C-Core 252, and the conductor assembly 232 wrapped around the lower portion of the C-Core 252. For each C-Core actuator 230, the C-Core 252 and the I-Core 250 are mounted so that there is the gap 254 between the C-Core 252 and the I-Core 250. In one embodiment, the gap 254 is in the range of between approximately 0 and 800 micrometers.

In one embodiment, (i) the I-Core 250 is generally rectangular plate shaped; and (ii) the C-Core 252 is shaped generally like a squared “C” and can be referred to an electromagnet. The C-Core 252 and the I-Core 250 are each substantially rigid, and can be made of a magnetic material such as iron, silicon steel or Ni—Fe steel. In one embodiment, the magnetic material is laminated in thin (e.g., 0.5 mm) sheets parallel to the plan of FIG. 2A. In FIGS. 2A and 2B, the conductor assembly 232 is asymmetrically located on the C-Core actuator 230. Further, the conductor assembly 232 is held in a substantially fixed position relative to the C-Core 252.

FIG. 2C is a simplified perspective view of the C-Core 252 and the conductor assembly 232, and FIG. 2D is a cut-away view taken on line 2D-2D in FIG. 2C. In this embodiment, the C-Core 252 shaped generally like a squared “C” and has a generally “C” shaped cross-section. In this embodiment, the C-Core 252 includes (i) a generally straight first transverse leg 260 that forms one leg of the C-Core 252, (ii) a generally straight second transverse leg 262 that forms another leg of the C-Core 252, and (iii) a generally straight connector region 264 that extends between and connects the transverse legs 260, 262 together. In this embodiment, (i) the transverse legs 260, 262 are spaced apart and are approximately parallel to each other, and (ii) the transverse legs 260, 262 are approximately perpendicular to the connector region 264.

It should be appreciated by those skilled in the art that other shapes are possible for the C-Core, depending on the specific application. For example, (i) either of the two transverse legs 260, 262 could be curved or irregularly shaped, (ii) the connector region 264 could be curved or irregularly shaped, (iii) the connector region 264 need not be perpendicular to the two transverse legs 260, 262, or (iv) the two transverse legs 260, 262 need not be parallel to each other. Additionally, the I-Core can have a non-rectangular or irregular shape to meet the requirements of a particular application. The magnitude and direction of the force produced by the C-Core actuator 230 is determined by the size and shape of the gap 254 between the C-Core 252 and the I-Core 250. Any shapes of C-Core 252 and I-Core 250 that create magnetic flux across the same size and shape gap 254 are equivalent to the embodiment shown. For example, the C-Core could be a somewhat circular C-shape where the two transverse legs and the connector region are smoothly blended together.

In one embodiment, the conductor assembly 232 includes a coil 270 and a conductor housing 272 that are fixedly secured to the first transverse leg 260 of the C-Core 252. Alternatively, if the conductor assembly 232 is not actively cooled, it can be designed without the conductor housing 272.

FIG. 2E is a simplified perspective view of the C-Core 252 and the coil 270 (without the conductor housing 272 illustrated in FIGS. 2C and 2D). Referring to FIGS. 2D and 2E, the coil 270 is wrapped around one of the parallel legs 260, 262 of the C-Core 252. This configuration can provide the same type of force and efficiency as a similarly sized E-Core (not shown), but the asymmetric configuration allows for the moving the pushpoint 234 (illustrated in FIG. 1) towards one side of the C-Core actuator 230 (illustrated in FIGS. 2A and 2B) and the coil 270 heat towards the other side. Either or both of these aspects can be an advantage in a modern lithography stage.

Stated in another fashion, because the coil 270 is wrapped around one of the transverse legs 260, 262, e.g. the first transverse leg 260 (as opposed to the connector region 264), the asymmetrical configuration moves a portion of the heat generating component (the coil 270) away from the second transverse leg 262, while still maintaining the push point 234 (illustrated as an arrow) of the actuator 230 near the center of the C-Core 252. This asymmetric design allows for the coil 270 of each actuator 230 to be positioned farther from sensitive components and the actuator push point 234 to be positioned closer to a desired location, such as in line with center of gravity 36 (illustrated in FIG. 1) of the object being moved by the actuator 230.

Further, because the coil 270 is wrapped around one of the parallel legs 260, 262 instead of the connector region 264, it is much easier to position on the C-Core 252. The coil 270 can be made of metal such as copper or any substance or material responsive to electrical current and capable of creating a magnetic field such as metals and superconductors.

Referring back to FIG. 1, with this design, each actuator 30 can be secured to the first stage 14 and the second stage 15 so that the first transverse leg 260 (illustrated in phantom with the conductor assembly 232 wrapped there around) is farther away from the supporting portion 14A of the stage 14 than the second transverse leg 262. More specifically, in the embodiment illustrated in FIG. 1, for each actuator 30, the first transverse leg 260 (with the conductor assembly 232 wrapped there around) is farther away from the supporting portion 14A of the stage 14 in the vertical direction (along the Z axis) than the second transverse leg 262. Stated in another fashion, with this design, for each actuator 30, the second transverse leg 262 is closer to the supporting portion 14A than the first transverse leg 260 (with the conductor assembly 232 wrapped there around).

Referring back to FIG. 2D, the conductor housing 272 defines a fluid passageway 274 that is adjacent to and that encloses the coil 270. In one embodiment, the housing 272 is a hollow somewhat toroidally shaped box that encloses the coil 270, and the passageway 274 also encloses the coil 270. With this design, the circulation fluid 20 (illustrated in FIG. 1) can be directed around the coil 270 to cool and/or control the temperature of the coil 270.

FIG. 2F is a simplified illustration of the C-Core 252 and the coil 270. FIG. 2F illustrates a number of the dimensions of the C-Core 252 and the coil 270. More specifically, (i) dimension A is the thickness of the connector region 264; (ii) dimension B is the thickness of the second transverse leg 262; (iii) dimension C is the thickness of the first transverse leg 260; (iv) dimension D is a width of the coil 270; and (v) dimension F is the thickness of the coil 270. In some embodiments, the dimensions A, B, and C are approximately equal. Further, dimension E is the combined length of the C-core 252, the coil 270 and the conductor housing 272 (not shown in FIG. 2F); and dimension G is the thickness of the combination. One non-exclusive example has the following characteristics (i) dimensions A, B, and C are approximately 15 mm; (ii) dimension D is approximately 5 mm; (iii) dimension E is approximately 50 mm; (iv) dimension F is approximately 15 mm; and (v) dimension G is approximately 35 mm.)

In this embodiment, the overall width (dimension E) of the C-Core 252 is approximately the same as an equivalently powered E-Core (not shown), but the thickness (dimension G) is typically increased by A/2. The C-Core 252 illustrated herein provides approximately the same force characteristics of as an E-Core that has the same overall width but a lesser thickness. Compared to an E-Core, in this design, the actuator push point 234 is moved further to the left and the heat from the coil 270 is moved to the right. For some applications, such as lithography stages, these differences are a significant benefit.

Possible benefits include, but are not limited to (i) moving the push point 234 closer to a stage center of gravity 36 (illustrated in FIG. 1), and (ii) moving the heat generating coil 270 farther from sensitive components. Stated in another fashion, the problems of the E-Core pushpoint being too far from the stage center of gravity 36 and the heat generating coil being too close to sensitive components are solved by replacing the E-Core actuator with an asymmetric C-Core actuator. An additional advantage is that more of the coil 270 is now on the “outside” of the C-Core 252. With this design, it can be easier to provide cooling and electrical connections for the coil 270.

FIG. 2G is a simplified side illustration of another actuator pair 280 having features of the present invention. In this embodiment, the actuator pair 280 includes a first actuator 230A and a second actuator 230B that are similar to the corresponding components described above. However, in this embodiment, the actuators 230A, 230B share a common I-Core 250. In this embodiment, (i) the first actuator 230A includes the C-Core 252 and the conductor assembly 232 that are spaced apart the gap 254 from the common I-Core 250, and that are attracted to the common I-Core 250 when power is directed to the conductor assembly 232; and (ii) the second actuator 230B includes the C-Core 252 and the conductor assembly 232 that are spaced apart the gap 254 from the common I-Core 250, and that are attracted to the common I-Core 250 when power is directed to the conductor assembly 232. In this embodiment, the I-Core assembly includes a single I-Core 250.

FIG. 3 is a schematic view illustrating an exposure apparatus 328 useful with the present invention. The exposure apparatus 328 includes the apparatus frame 380, an illumination system 382 (irradiation apparatus), a reticle stage assembly 384, an optical assembly 386 (lens assembly), and a wafer stage assembly 310. The stage assemblies provided herein can be used as the wafer stage assembly 310. Alternately, with the disclosure provided herein, the stage assemblies provided herein can be modified for use as the reticle stage assembly 384.

The exposure apparatus 328 is particularly useful as a lithographic device that transfers a pattern (not shown) of an integrated circuit from the reticle 388 onto the semiconductor wafer 390. The exposure apparatus 330 mounts to the mounting base 338, e.g., the ground, a base, or floor or some other supporting structure.

The apparatus frame 380 is rigid and supports the components of the exposure apparatus 330. The design of the apparatus frame 380 can be varied to suit the design requirements for the rest of the exposure apparatus 328.

The illumination system 382 includes an illumination source 392 and an illumination optical assembly 394. The illumination source 392 emits a beam (irradiation) of light energy. The illumination optical assembly 394 guides the beam of light energy from the illumination source 392 to the optical assembly 386. The beam illuminates selectively different portions of the reticle 388 and exposes the semiconductor wafer 390. In FIG. 3, the illumination source 392 is illustrated as being supported below the reticle stage assembly 384. Alternatively, the illumination source 392 the energy beam from the illumination source 392 can be directed above the reticle stage assembly 384.

The optical assembly 386 projects and/or focuses the light passing through the reticle to the wafer. Depending upon the design of the exposure apparatus 328, the optical assembly 386 can magnify or reduce the image illuminated on the reticle.

The reticle stage assembly 384 holds and positions the reticle 388 relative to the optical assembly 386 and the wafer 390. Similarly, the wafer stage assembly 310 holds and positions the wafer 390 with respect to the projected image of the illuminated portions of the reticle 388.

There are a number of different types of lithographic devices. For example, the exposure apparatus 328 can be used as scanning type photolithography system that exposes the pattern from the reticle 388 onto the wafer 390 with the reticle 388 and the wafer 390 moving synchronously. Alternatively, the exposure apparatus 328 can be a step-and-repeat type photolithography system that exposes the reticle 388 while the reticle 388 and the wafer 390 are stationary.

However, the use of the exposure apparatus 328 and the stage assemblies provided herein are not limited to a photolithography system for semiconductor manufacturing. The exposure apparatus 328, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, inspection machines and disk drives.

As described above, a photolithography system according to the above described embodiments can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

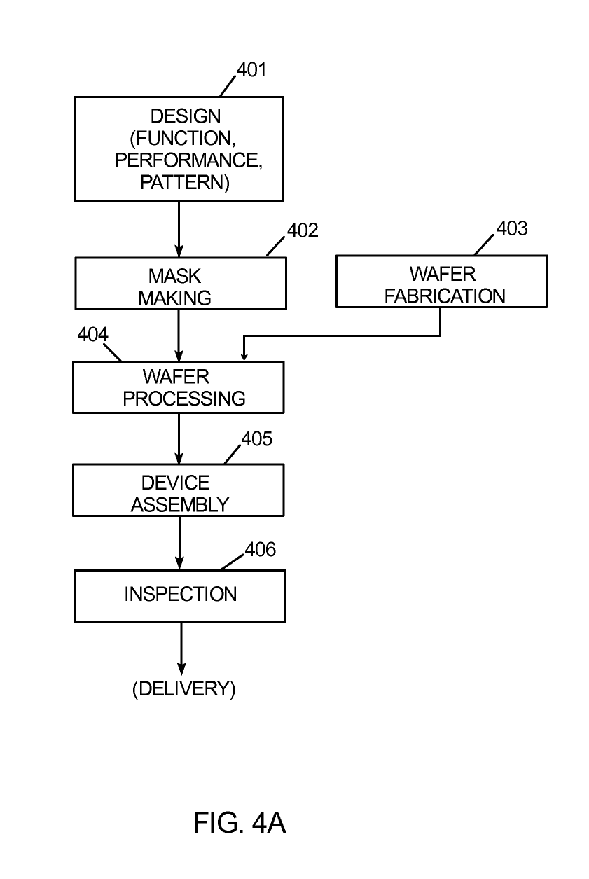

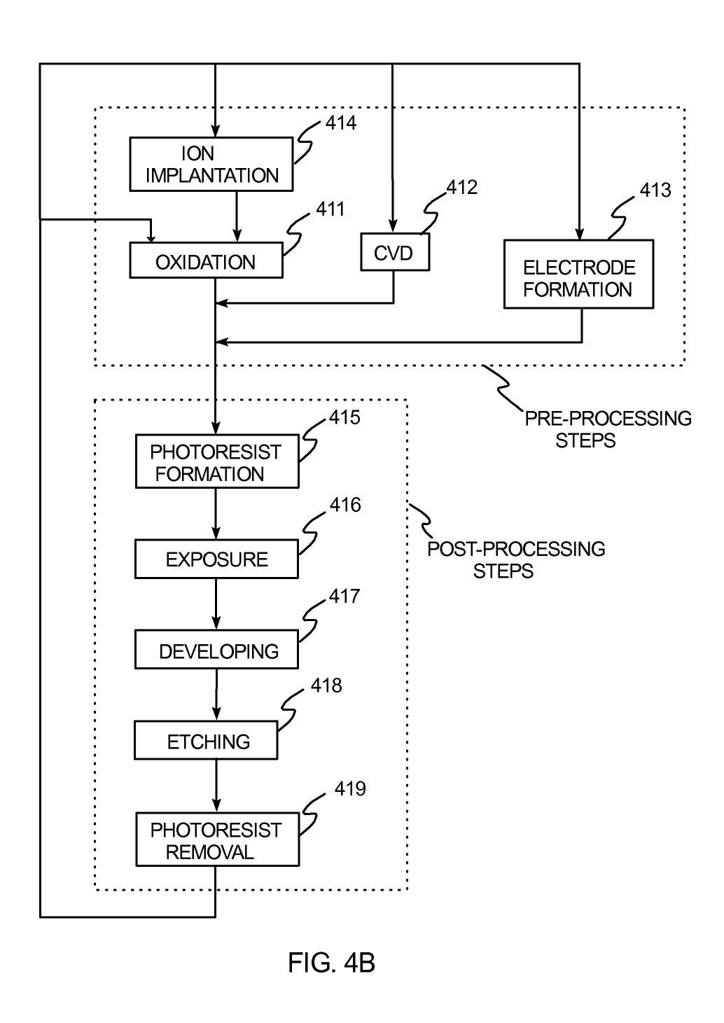

Further, semiconductor devices can be fabricated using the above described systems, by the process shown generally in FIG. 4A. In step 401 the device's function and performance characteristics are designed. Next, in step 402, a mask (reticle) having a pattern is designed according to the previous designing step, and in a parallel step 403 a wafer is made from a silicon material. The mask pattern designed in step 402 is exposed onto the wafer from step 403 in step 404 by a photolithography system described hereinabove in accordance with the present invention. In step 405 the semiconductor device is assembled (including the dicing process, bonding process and packaging process), finally, the device is then inspected in step 406.

FIG. 4B illustrates a detailed flowchart example of the above-mentioned step 404 in the case of fabricating semiconductor devices. In FIG. 4B, in step 411 (oxidation step), the wafer surface is oxidized. In step 412 (CVD step), an insulation film is formed on the wafer surface. In step 413 (electrode formation step), electrodes are formed on the wafer by vapor deposition. In step 414 (ion implantation step), ions are implanted in the wafer. The above mentioned steps 411-414 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 415 (photoresist formation step), photoresist is applied to a wafer. Next, in step 416 (exposure step), the above-mentioned exposure device is used to transfer the circuit pattern of a mask (reticle) to a wafer. Then in step 417 (developing step), the exposed wafer is developed, and in step 418 (etching step), parts other than residual photoresist (exposed material surface) are removed by etching. In step 419 (photoresist removal step), unnecessary photoresist remaining after etching is removed.

Multiple circuit patterns are formed by repetition of these preprocessing and post-processing steps.

While the particular stage assembly as shown and disclosed herein is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A mover assembly for moving a stage, the mover assembly comprising:
a first actuator that is coupled to the stage, the first actuator including (i) a C-Core that is somewhat “C” shaped and includes a first transverse leg, a second transverse leg that is spaced apart from the first transverse leg, and a connector region that connects the transverse legs; (ii) a coil that is wrapped around the first transverse leg; and (iii) an I core that is spaced apart a gap from the C-Core.

2. The mover assembly of claim 1 further comprising a control system that directs current to the coil to attract the cores together.

3. The mover assembly of claim 1 further comprising a second actuator that is coupled to the stage, the second actuator including (i) a C-Core that is somewhat “C” shaped and includes a first transverse leg, a second transverse leg that is spaced apart from the first transverse leg, and a connector region that connects the transverse legs; (ii) a coil that is wrapped around the first transverse leg; and (iii) an I core that is spaced apart a gap from the C-Core.

4. The mover assembly of claim 3 further comprising a control system that directs current to the coil of the first actuator to attract the cores of the first actuator together, and directs current to the coil of the second actuator to attract the cores of the second actuator together.

5. The mover assembly of claim 1 further comprising a second actuator that is coupled to the stage, the second actuator including (i) a C-Core that is somewhat “C” shaped and includes a first transverse leg, a second transverse leg that is spaced apart from the first transverse leg, and a connector region that connects the transverse legs; and (ii) a coil that is wrapped around the first transverse leg; wherein the coil and the C-Core of the second actuator are spaced apart a gap from the I-Core of the first actuator.

6. The mover assembly of claim 1 wherein the first actuator is a variable reluctance actuator.

7. A stage assembly for moving a device, the stage assembly comprising: (i) a stage that retains the device, and (ii) the mover assembly of claim 1 that moves the stage.

8. The stage assembly of claim 7 wherein the stage includes a supporting portion that supports the device, and wherein the position of the second transverse leg is closer to the supporting portion than the first transverse leg.

9. An exposure apparatus including an illumination source and the stage assembly of claim 7 that moves the stage relative to the illumination system.

10. A process for manufacturing a device that includes the steps of providing a substrate and forming an image to the substrate with the exposure apparatus of claim 9.

11. A stage assembly for moving a device, the stage assembly comprising:
a stage that retains the device, the stage including;
a mover assembly that moves the stage, the mover assembly comprising:
a first actuator that is coupled to the stage, the first actuator including (i) a C-Core that is somewhat “C” shaped and includes a first transverse leg, a second transverse leg that is spaced apart from the first transverse leg, and a connector region that connects the transverse legs; and (ii) a coil that is wrapped around the first transverse leg;
a second actuator that is coupled to the stage, the second actuator including (i) a C-Core that is somewhat “C” shaped and includes a first transverse leg, a second transverse leg that is spaced apart from the first transverse leg, and a connector region that connects the transverse legs; (ii) a coil that is wrapped around the first transverse leg;
an I-Core assembly that is spaced apart a first gap from the C-Core of the first actuator and a second gap from the C-Core of the second actuator; and
a control system that directs current to the coil of the first actuator to attract the C-Core of the first actuator to the I-Core assembly, and directs current to the coil of the second actuator to attract the C-Core of the second actuator to the I-Core assembly.

12. The stage assembly of claim 11 wherein each of the actuators is a variable reluctance actuator.

13. The stage assembly of claim 11 wherein the I-Core assembly includes a pair of spaced apart I-Cores.

14. The stage assembly of claim 11 wherein the I-Core assembly includes a single I-Core.

15. The stage assembly of claim 11 wherein the stage includes a supporting portion that supports the device thereon, and wherein the position of the second transverse legs of the first actuator and the second actuator are closer to the supporting portion than the first transverse legs of the first actuator and the second actuator.

16. An exposure apparatus including an illumination source and the stage assembly of claim 11 that moves the stage relative to the illumination system.

17. A process for manufacturing a device that includes the steps of providing a substrate and forming an image to the substrate with the exposure apparatus of claim 16.

18. A method for positioning a first stage relative to a second stage, the method comprising the steps of:
providing a first actuator that includes (i) a C-Core that is somewhat “C” shaped and includes a first transverse leg, a second transverse leg that is spaced apart from the first transverse leg, and a connector region that connects the transverse legs; (ii) a coil that is wrapped around the first transverse leg; and (iii) an I-Core assembly that is spaced apart a gap from the C-Core;
coupling the C-Core of the first actuator to one of the stages;
coupling the I-Core assembly to the other of the stages; and
directing current to the coil of the first actuator with a control system to attract the C-Core to the I-Core assembly.

19. The method of claim 18 further comprising the steps of:
providing a second actuator that includes (i) a C-Core that is somewhat “C” shaped and includes a first transverse leg, a second transverse leg that is spaced apart from the first transverse leg, and a connector region that connects the transverse legs; and (ii) a coil that is wrapped around the first transverse leg;
coupling the C-Core of the second actuator to one of the stages;
directing current to the coil of the second actuator with the control system to attract the C-Core of the second actuator to the I-Core assembly.

20. A method for manufacturing a device that includes the steps of providing a substrate, securing the substrate to the first stage, positioning the substrate with first stage using the method of claim 18, and forming an image on the substrate.

21. The method of claim 18 wherein the stage includes a supporting portion that supports the device thereon, and wherein the step of providing the first actuator includes positioning the second transverse leg of the first actuator closer to the supporting portion than the first transverse leg of the first actuator.
